(19) United States
(12) Patent Application Publication
(10) Pub. No.: US 2024/0312232 A1
(43) Pub. Date: Sep. 19, 2024

(54) DOCUMENT INFORMATION EXTRACTION

(71) Applicant: INTERNATIONAL BUSINESS MACHINES CORPORATION, ARMONK, NY (US)

(72) Inventors: Fei Wang, Dalian (CN); Zhong Fang Yuan, Xi'an (CN); Tong Liu, Xi'an (CN); Han Qiao Yu, Shaanxi Province (CN); Xiang Yu Yang, Xi'an (CN)

(21) Appl. No.: 18/184,014

(22) Filed: Mar. 15, 2023

(51) Int. Cl. G06V 30/412; G06V 30/19

(52) U.S. Cl. CPC G06V 30/412; G06V 30/19093; G06V 30/1918

(57) ABSTRACT

An embodiment for a method of extracting information from documents using knowledge graphs and prompt-based learning. The embodiment may receive a document and perform optical character recognition (OCR) to obtain OCR text lines and associated bounding boxes. The embodiment may encode each of the obtained OCR text lines into semantic vectors and each of the associated bounding boxes into position vectors to generate a knowledge graph using fusion vectors derived therefrom. The embodiment may receive a query including a key value. The embodiment may identify a series of candidate nodes including a series of most similar nearby nodes positioned near a first node associated with the key value. The embodiment may generate prompt template to determine closeness of the candidate nodes to the key value and calculate associated confidence levels. The embodiment may output extraction information associated with the candidate node having a highest calculated confidence level.

### BACKGROUND

The present application relates generally to computers, and more particularly, to extracting information from documents using knowledge graphs and prompt-based learning.

Digital data has become a primary source of information and content. Digital data is commonly stored in digital documents containing data in the form of tables, images, text and so forth. Many businesses seek to extract structured information from various digital documents such as receipts, invoices, standardized forms, records, and more. Software-based data extraction from digital documents typically involves scanning the digital document using techniques such as Optical Character Recognition (OCR) to identify and characterize the contents of a given digital document to allow for more precise data extraction.

### SUMMARY

According to one embodiment, a method, computer system, and computer program product for extracting information from documents using knowledge graphs and prompt-based learning is provided. The embodiment may include receiving a document and performing optical character recognition (OCR) on the received document to obtain OCR text lines and associated bounding boxes. The embodiment may further include encoding each of the obtained OCR text lines into semantic vectors and each of the associated bounding boxes into position vectors. The embodiment may also include generating a series of fusion vectors by combining the semantic vectors and the position vectors. The embodiment may further include building a knowledge graph corresponding to the received document by calculating distances between the generated series of fusion vectors, forming edges where the calculated distances exceed a threshold. The embodiment may also receive a query including a key value for extracting information from the received document. The embodiment may further include, in response to receiving the query including the key value, identifying a first node in the knowledge graph corresponding to the OCR text lines including the key value. The embodiment may also include identifying a series of candidate nodes including a series of most similar nearby nodes positioned near the first node. The embodiment may also include generating a prompt template configured to determine closeness of the candidate nodes to the key value and calculate associated confidence levels. The embodiment may further include outputting to a user extracted information associated with the candidate node having a highest calculated confidence level.

### BRIEF DESCRIPTION OF THE SEVERAL VIEWS OF THE DRAWINGS

These and other objects, features and advantages of the present disclosure will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an operational flowchart for a process of extracting information from documents using knowledge graphs and prompt-based learning according to at least one embodiment;

FIG. 3 illustrates an exemplary process for constructing a document graph for a received document using semantic information and position information according to at least one embodiment; and

FIG. 4 illustrates an example of zero-sample information extraction using a prompt template to obtain an exemplary output according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. The present disclosure may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present application relate generally to computers, and more particularly, to extracting information from documents using knowledge graphs and prompt-based learning. The following described exemplary embodiments provide a system, method, and program product to, among other things, receive a document and perform optical character recognition (OCR) on the received document to obtain OCR text lines and associated bounding boxes, encode each of the obtained OCR text lines into semantic vectors and each of the associated bounding boxes into position vectors, generate a series of fusion vectors by combining the semantic vectors and the position vectors, and build a knowledge graph corresponding to the received document by calculating distances between the generated series of fusion vectors, forming edges where the calculated distances exceed a threshold. Thereafter the following described exemplary embodiments may receive a query including a key value for extracting information from the received document, in response to receiving the query including the key value, identify a first node in the knowledge graph corresponding to the OCR text lines including the key value, identify a series of candidate nodes including a series of most similar nearby nodes positioned near the first node, generate a prompt template configured to determine closeness of the candidate nodes to the key value and calculate associated confidence levels, and output to a user extracted information associated with the candidate node having a highest calculated confidence level. Therefore, the presently described embodiments have the capacity to improve extracting of information from documents by using knowledge graphs and prompt-based learning. Presently described embodiments combine semantic knowledge graph construction of documents based on layout with prompt learning semantic extraction to automatically identify the layout structure of documents without the need for traditional template constructions. To establish potential relationships between a given key and value, presently described embodiments use different text blocks obtained after OCR as nodes of a knowledge graph and correlates the nodes based on the generated location and semantic information from the knowledge graph. When the extraction of the key value structure data is completed, presently described embodiments provide for search capabilities to determine the location of the key value and obtain the potential set of candidate nodes corresponding to the key value based on the constructed knowledge graph. Using prompt technique for key and candidate value discriminations, presently described embodiments provide for a final key value structured output to be obtained. Certain presently described embodiments provide for increased accuracy in zero-sample prediction scenarios that reach up to 85% or higher while only requiring 3-5 samples of fine-tuning to reach more than 95% accuracy.

As previously described, digital data has become a primary source of information and content. Digital data is commonly stored in digital documents containing data in the form of tables, images, text and so forth. Many businesses seek to extract structured information from various digital documents such as receipts, invoices, standardized forms, records, and more. Software-based data extraction from digital documents using software typically involves scanning the digital document using techniques such as Optical Character Recognition (OCR) to identify and characterize the contents of a given digital document to allow for more precise data extraction.

However, extracting structured information from documents is frequently a difficult problem in the field of OCR information extraction. Algorithm engineers are frequently confronted with a wide range of documents including various shapes and information types, and they must extract structured data of the key-value type from them. Traditional methods frequently employ a template method to extract information, which entails processing a target document into a state that can be recognized with a fixed angle and size, and then taking a fixed size subgraph using OCR through a fixed position, extracting the information in the subgraph, and assuming that a certain type of information will be extracted from the fixed position. This may give rise to a number of challenges. For example, in some traditional template-style approaches to information extraction, a mere 15-degree inclination of a target document could cause the entirety of the extraction results to be incorrect. The main disadvantage of the traditional template approaches is that they are very labor-intensive, sometimes requiring more weeks or months of development and testing time for each type of document on average. Additionally, template annotation for these approaches is typically difficult. More recently, approaches have emerged that inject layoutXLM and other deep learning algorithms based on layout analysis, but the annotation cost of these algorithm are relatively high, and there are significant limitations in the scope of the application of these methods, such as not supporting multi-hop extraction, detail extraction, and other scenarios.

Accordingly, a method, computer system, and computer program product for improving extracting of information from documents using knowledge graphs and prompt-based learning is provided. The method, system, and computer program product may receive a document and perform optical character recognition (OCR) on the received document to obtain OCR text lines and associated bounding boxes. The method, system, computer program product may encode each of the obtained OCR text lines into semantic vectors and each of the associated bounding boxes into position vectors. The method, system, computer program product may generate a series of fusion vectors by combining the semantic vectors and the position vectors. The method, system, computer program product may then build a knowledge graph corresponding to the received document by calculating distances between the generated series of fusion vectors, forming edges where the calculated distances exceed a threshold. Next, the method, system, computer program product may receive a query including a key value for extracting information from the received document. The method, system, computer program product may then, in response to receiving the query including the key value, identify a first node in the knowledge graph corresponding to the OCR text lines including the key value. The method, system, computer program product may identify a series of candidate nodes including a series of most similar nearby nodes positioned near the first node. The method, system, computer program product may then generate a prompt template configured to determine closeness of the candidate nodes to the key value and calculate associated confidence levels. Thereafter, the method, system, computer program product may output to a user extracted information associated with the candidate node having a highest calculated confidence level. In turn, the method, system, computer program product has provided for improved extracting of information from documents by using knowledge graphs and prompt-based learning. Presently described embodiments combine semantic knowledge graph construction of documents based on layout with prompt learning semantic extraction to automatically identify the layout structure of documents without the need for traditional template constructions. To establish potential relationships between a given key and value, presently described embodiments use different text blocks obtained after OCR as nodes of a knowledge graph and correlates the nodes based on the generated location and semantic information from the knowledge graph. When the extraction of the key value structure data is completed, presently described embodiments provide for search capabilities to determine the location of the key value and obtain the potential set of candidate nodes corresponding to the key value based on the constructed knowledge graph. Using prompt technique for key and candidate value discriminations, presently described embodiments provide for a final key value structured output to be obtained. Certain presently described embodiments provide for increased accuracy in zero-sample prediction scenarios that reach up to 85% or higher while only requiring 3-5 samples of fine-tuning to reach more than 95% accuracy.

The present invention may be a system, a method, and/or a computer program product at any possible technical detail level of integration. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

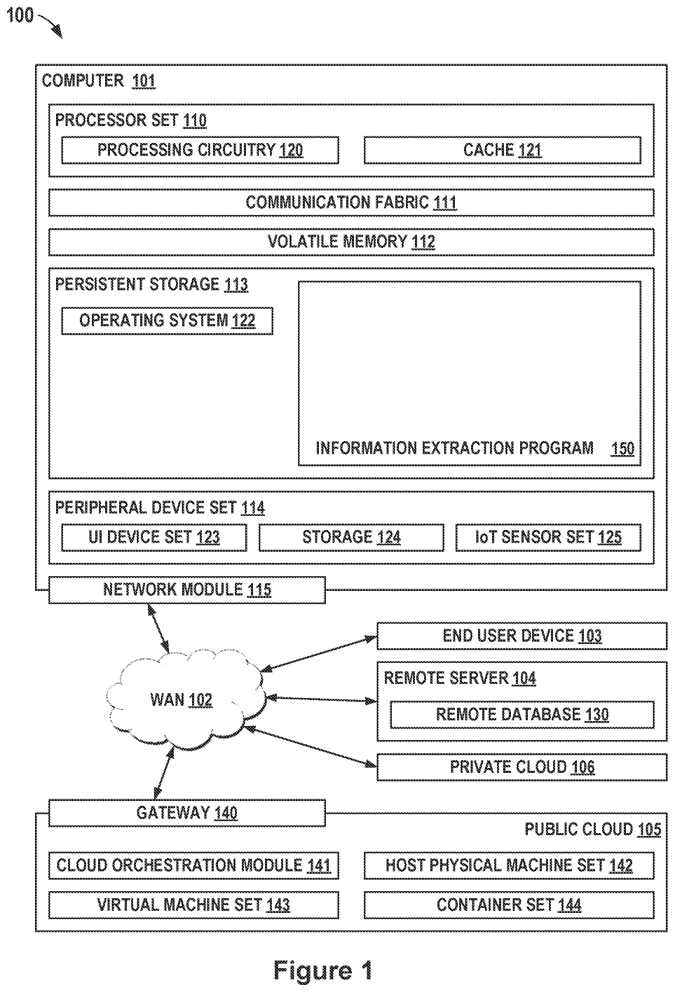

Referring now to FIG. 1, computing environment 100 contains an example of an environment for the execution of at least some of the computer code involved in performing the inventive methods, such as information extraction program/code 150. In addition to information extraction code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and information extraction code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in information extraction code 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers

that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in information extraction code 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the information extraction program 150 may be a program capable of receiving a document and performing optical character recognition (OCR) on the received document to obtain OCR text lines and associated bounding boxes. Information extraction program 150 may encode each of the obtained OCR text lines into semantic vectors and each of the associated bounding boxes into position vectors. Next, information extraction program 150 may generate a series of fusion vectors by combining the semantic vectors and the position vectors. Information extraction program 150 may then build a knowledge graph corresponding to the received document by calculating distances between the generated series of fusion vectors, forming edges where the calculated distances exceed a threshold. Information extraction program 150 may then receive a query including a key value for extracting information from the received document. Next, information extraction program 150 may in response to receiving the query including the key value, identify a first node in the knowledge graph corresponding to the OCR text lines including the key value. Then, information extraction program 150 may identify a series of candidate nodes including a series of most similar nearby nodes positioned near the first node. Next, information extraction program 150 may generate a prompt template configured to determine closeness of the candidate nodes to the key value and calculate associated confidence levels. Thereafter, information extraction program 150 may output to a user extracted information associated with the candidate node having a highest calculated confidence level. Described embodiments thus provide for improved improved extracting of information from documents by using knowledge graphs and prompt-based learning. Presently described embodiments combine semantic knowledge graph construction of documents based on layout with prompt learning semantic extraction to automatically identify the layout structure of documents without the need for traditional template constructions. To establish potential relationships between a given key and value, presently described embodiments use different text blocks obtained after OCR as nodes of a knowledge graph and correlates the nodes based on the generated location and semantic information from the knowledge graph. When the extraction of the key value structure data is completed, presently described embodiments provide for search capabilities to determine the location of the key value and obtain the potential set of candidate nodes corresponding to the key value based on the constructed knowledge graph. Using prompt technique for key and candidate value discriminations, presently described embodiments provide for a final key value structured output to be obtained. Certain presently described embodiments may provide for increased accuracy in zero-sample prediction scenarios that reach up to 85% or higher while only requiring 3-5 samples of fine-tuning to reach more than 95% accuracy.

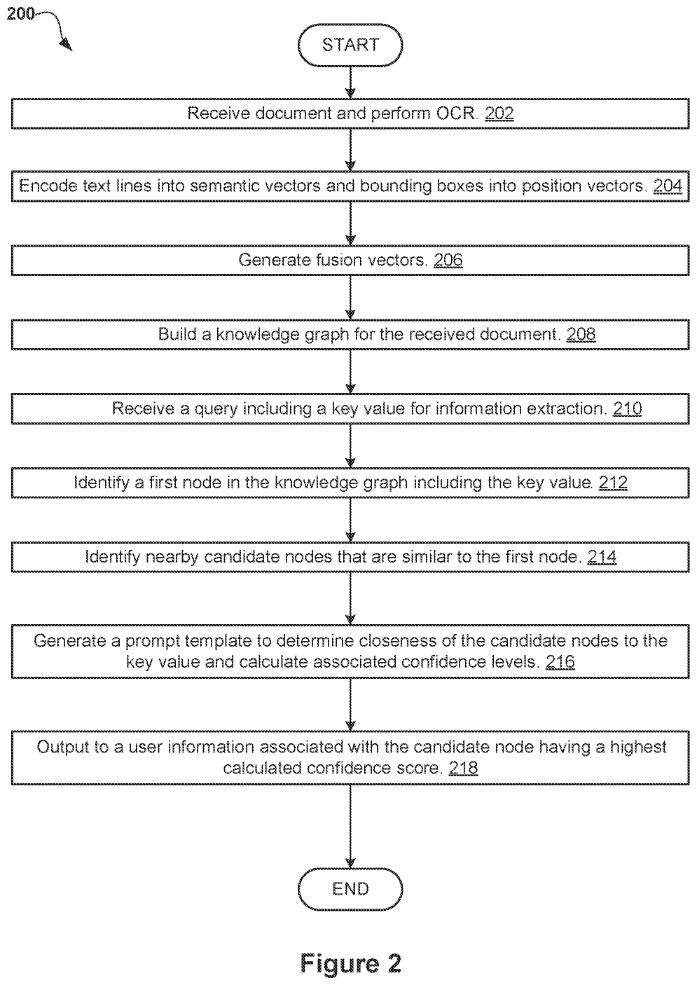

Referring now to FIG. 2, an operational flowchart is provided depicting an illustrative process 200 of extracting information from documents using knowledge graphs and prompt-based learning according to at least one embodiment.

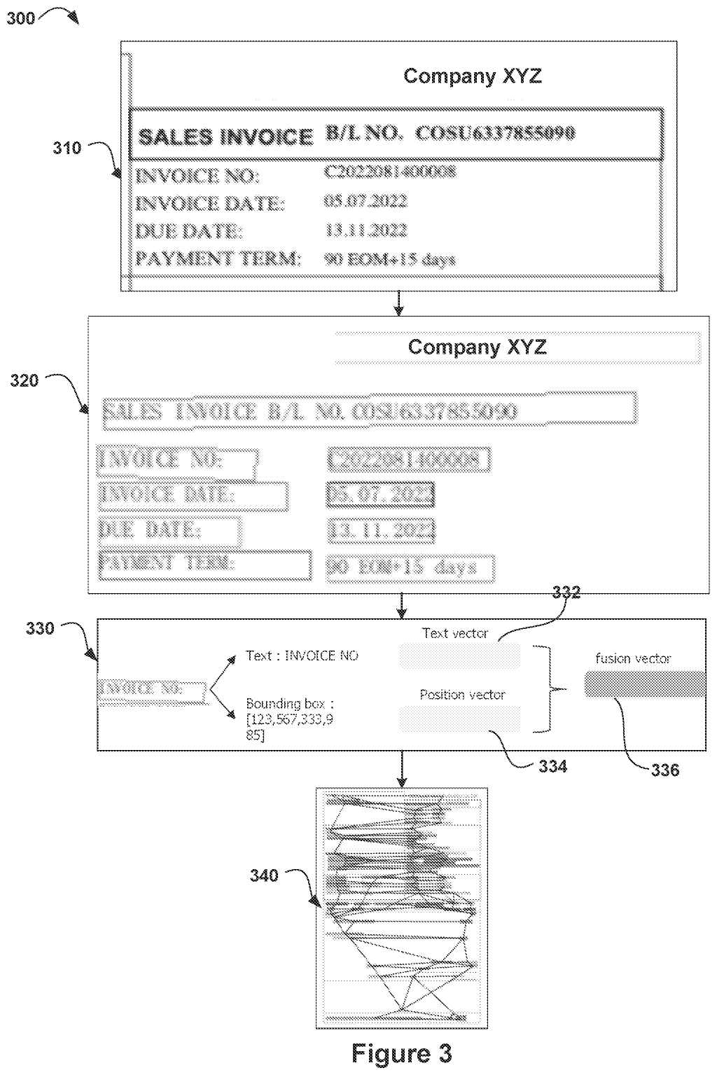

At 202, information extraction program 150 may receive a document and performing optical character recognition (OCR) on the received document to obtain OCR text lines and associated bounding boxes. In embodiments, information extraction program 150 may receive a variety of documents, such as, for example, receipts, invoices, standardized forms, records, bills, or any other document a user may want to extract structured information from. In embodiments, information extraction program 150 may be configured to employ any suitable additional known OCR techniques depending upon the type of received document. For example, in embodiments information extraction program 150 may be configured to employ optical character recognition (OCR), optical word recognition (OWR), intelligent character recognition (ICR), intelligent word recognition (IWR) and so forth depending on the received document type. These techniques may be used to obtain semantic and layout information via a series of identified text lines and associated bounding boxes. The obtained text lines and associated bounding boxes may be used in combination with the below-described steps to construct a knowledge graph for the received document. FIG. 3 illustrates an exemplary process 300 for constructing a document graph for a received document using semantic information and layout information according to at least one embodiment and will be referenced throughout the discussion of process 200. In FIG. 3, a portion of an exemplary received document ‘D1’ is shown at 310. At 320, an exemplary information extraction program 150 has performed OCR techniques on an exemplary received document ‘D1’. The exemplary information extraction program 150 thus obtains text lines and associated bounding boxes at 320. At 330, a specific text line for ‘INVOICE NO’ is shown with associated bounding box ‘[123,567,333,9,85]’.

Next, at 204, information extraction program 150 may encode each of the obtained OCR text lines into semantic vectors and each of the associated bounding boxes into position vectors. In embodiments, information extraction program 150 may utilize a pre-trained neural network-based encoder such as the ‘robustly optimized Bidirectional Encoder representation from Transformers approach’ (RoBERTa) as the encoder for the obtained text lines to generate semantic vectors, and a pre-trained neural network-based encoders such as a LayoutLM position encoder to encode the associated bounding box for the text lines to generate position vectors. In other embodiments, any suitable encoders for generating embeddings having the desired properties (depending on the characteristics received document) may be used, such as, for example, universal sentence encoders, bidirectional encoder representations from transformers, generative pre-trained transformers, doc2vec, etc. As shown in the example depicted in FIG. 3, at 330, information extraction program 150 may be configured to utilize RoBERTa to encode the text line ‘INVOICE NO’ to generate the semantic vector 332, and LayoutLM position encoder (a variant of Bidirectional Encoder representation from Transformers architecture) to encode the associated bounding box into a position vector 334.

At 206, information extraction program 150 may generate a series of fusion vectors by combining the semantic vectors and the position vectors. As shown in FIG. 3, fusion vector 336 is generated by combining semantic vector 332 and position vector 334. To accomplish this information extraction program 150 may use a weighted sum or concatenation of each respective pair of vectors to generate a combined fusion vector which preserves the distinct information from the position and semantic vectors.

Next at 208, information extraction program 150 may build a knowledge graph corresponding to the received document by calculating distances between the generated series of fusion vectors, forming edges where the calculated distances exceed a threshold. In embodiments, information extraction program 150 may accomplish this by utilizing a K-Nearest neighbors (KNN) algorithm to perform neighbor discovery for all obtained text lines in the received document. If information extraction program 150 calculates the vector space distance between two given fusion vectors exceeds a certain threshold, information extraction program 150 may form an edge between these two nodes. Information extraction program 150 thus transforms the entire received document into a knowledge graph structure, as is shown at 340 in FIG. 3.

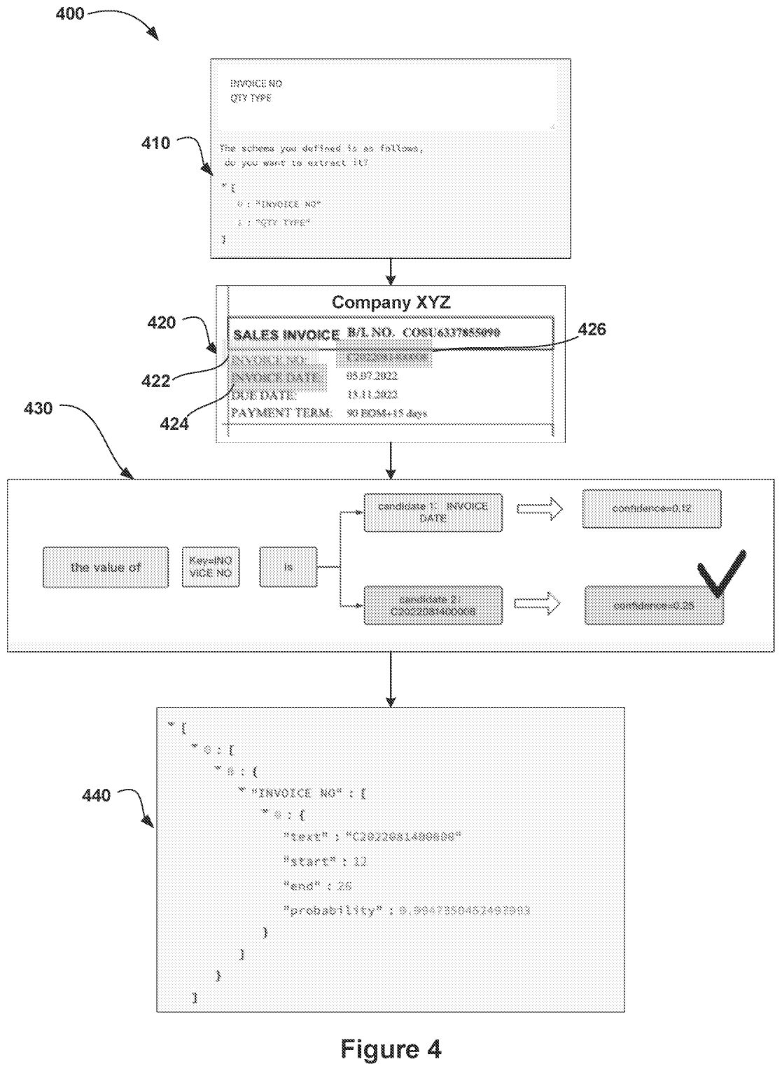

It should be noted that steps 202-208 of process 200 allow information extraction program 150 to generate a knowledge graph using multi-modal fusion vectors that account for both semantic and positional information within the received document and connects geometric neighbors. It may be appreciated that embodiments of information extraction program 150 include a document graph construction module (not shown) configured to employ a series of techniques and algorithms to characterize a received document and construct a knowledge graph as described above. Information extraction program 150 may ultimately utilize the generated knowledge graph to extract structured information from the received document by performing zero-sample information extraction based on prompt learning, as will be described in greater detail below in the description of steps 210-218. FIG. 4 illustrates an example of zero-sample information extraction using a prompt template to obtain an exemplary output according to at least one embodiment and will be referenced below. It may be appreciated that embodiments of information extraction program 150 further include an information extraction module (not shown) configured to employ prompt template learning techniques and a series of suitable algorithms suitable for performing zero-sample information extraction using a prompt template as will be described in greater detail below.

At 210, information extraction program 150 may receive a query including a key value for extracting information from the received document. The received query and key value may be manually input by a user in text form. FIG. 4 illustrates an example of zero-sample information extraction using a prompt template to obtain an exemplary output according to at least one embodiment. In embodiments, information extraction program 150 may be configured to receive a query including a key value that is input manually by a user interacting with a suitable user interface associated with information extraction program 150. In FIG. 4, an exemplary received query is shown at 410. At 410 information extraction program 150 has received a query from a user who manually input ‘INVOICE NO’ as a key value for extracting information from the received document.

Next, at 212, information extraction program may, in response to receiving the query including the key value, identify a first node in the knowledge graph corresponding to the OCR text lines including the key value. Returning to the example in FIG. 4, if the key value for extraction information is ‘INVOICE NO’, then information extraction program 150 may identify a first node in the knowledge graph that corresponds to the OCR text line including ‘INVOICE NO’. Information extraction program 150 may be configured to identify the first node corresponding to the OCR text lines included in the key value by employing suitable known natural language processing techniques (NLP) and algorithms capable of performing various NLP techniques, such as for example, combinations of named entity recognition, semantic similarity analyses, part-of-speech tagging, entity linking, and comparing of word embeddings. In FIG. 4, a portion of an exemplary received document is shown at 420, with an exemplary key value ‘INVOICE NO’ highlighted at 422 to indicate that it has been identified by information extraction program 150. At this step, information extraction program 150 would further identify a first node in the generated knowledge graph corresponding to this document and the specific OCR text lines and bounding boxe associated with ‘INVOICE NO’ (the key value).

At 214, information extraction program 150 may identify a series of candidate nodes including a series of most similar nearby nodes positioned near the first node. In embodiments, the ‘most similar nearby nodes’ may correspond to a preconfigured number of neighbor nodes positioned near the first node having the highest calculated similarity values when compared to the first node. In other embodiments, the ‘most similar nearby nodes’ may include neighbor nodes positioned near the first node having a calculated similarity value above a predetermined threshold value. The identified series of candidate nodes represent nodes that potentially include structured information that a user is attempting to extract based on the input key value. Information extraction program 150 may identify the candidate nodes by considering the first node associated with the key value as a central node, and then identifying neighbor nodes that are nearby to that central first node. In embodiments, information extraction program 150 may then order the similarity of the identified neighbor nodes, to find the most similar nearby nodes (potential candidate nodes), based on node vector matching degrees. For example, in embodiments information extraction program 150 may be configured to measure the distance or cosine similarity between the vector representations of the neighbor nodes to the vector representation of the first node associated with the key value. It will be appreciated that because the vector representations of the candidate nodes and the first node associated with the key values include fusion vectors generated based upon both semantic and position information, the identified similar nodes involve most closely related characteristics relating to both the meaning and context of the associated text lines and position or layouts of those text lines within the received document. Accordingly, information extraction program 150 may utilize the above-described techniques to calculate similarity values between each neighbor node and the first node. Finally, information extraction program 150 may identify a series of candidate based on the numerical similarity values for each of the neighbor nodes derived from the above-described techniques by selecting a preconfigured number of the most similar nearby nodes to the first node. For example, in some embodiments, information extraction program 150 may be configured to select the top 2 or 3 most similar neighbor nodes as candidate nodes. As shown in the example of FIG. 4 at 420, text lines ‘INVOICE DATE:’ at 424 and ‘C2022081400008’ at 426 are highlighted to indicate that information extraction program 150 has identified these values as corresponding to identified nearby neighbor nodes to the first node including the key value (INVOICE NO. at 422). At this step, information extraction program 150 would then determine similarity of the first node including the key value ‘INVOICE NO’ at 422 to the nearby nodes corresponding to the values ‘INVOICE DATE:’ at 424 and ‘C2022081400008’ at 426. In this example, information extraction program 150 determines that the nearby nodes corresponding to the values ‘INVOICE DATE:’ at 424 and ‘C2022081400008’ at 426 both have calculated similarity values when compared to the first node including the key value that exceed a predetermined threshold similarity value. In other embodiments, information extraction program 150 may identify the series of candidate nodes based on comparing the obtained similarity values to the other nearby candidate nodes and selecting a preconfigured number of closest candidate nodes. Information extraction program 150 must now determine which of the identified candidate nodes are most likely to be associated with the structured information (corresponding to the key value) that the user is attempting to extract.

At 216, information extraction program 150 may generate a prompt template configured to determine closeness of the identified candidate nodes to the key value and calculate associated confidence levels. Returning to the illustrative example in FIG. 4, at this step information extraction program 150 may generate a prompt template configured to determine the closeness of candidate nodes ‘INVOICE DATE’ and ‘C2022081400008’ from step 214 to the key value of ‘INVOICE NO’. In embodiments, the closeness of candidate nodes may be determined using vector matching degree, semantic similarity measures using known natural language processing models and algorithms, shortest path algorithms, determinations of shared properties or frequency of co-occurrence in the applicable knowledge graph, or a combination of these techniques. An exemplary prompt template for preforming this step is shown in FIG. 4 at 430. As shown at 430, the prompt template may be used to calculate and output confidence level (value) for each of the candidate nodes. At 430, the candidate node corresponding to ‘C2022081400008’ was the candidate node having the higher calculated confidence level of 0.25 when compared to the other candidate node corresponding to ‘INVOICE DATE’ which only had a calculated confidence score of 0.12.

Thereafter, at 218, information extraction program 150 may output to a user extracted information associated with the candidate node having a highest calculated confidence level. An exemplary output is shown at 440 in FIG. 4. As shown, information extraction program 150 generates an output to a user including the text associated with the candidate node having the highest calculated confidence level. At 440, the candidate node with the highest calculated confidence level was candidate 2, associated with the text line ‘C2022081400008’. In embodiments, the generated output including the candidate node with the highest calculated confidence level may further include ‘start’ and ‘end’ information corresponding to the position of the text associated with the candidate node, as well as a probability value. In embodiments, a probability value output by information extraction program 150 may be obtained by inputting the calculated confidence levels into a soft max function or other suitable functions configured to normalize the confidence levels by mapping each element each element considered to determine the confidence level to a value between 0 and 1, such that the sum of all the mapped values equals 1, making the output of the soft max function a valid probability distribution. At this step, information extraction program 150 has successfully output to the user the information corresponding to the candidate node that is most closely related to the key value input by the user. Information extraction program 150 considered both the semantics and positions of text lines and bounding boxes to generate a knowledge graph and utilize prompt templates to identify the closest nodes to the received query and associated key value.

It will be appreciated that information extraction program 150 thus provides for improved extracting of information from documents by using knowledge graphs and prompt-based learning. Presently described embodiments combine semantic knowledge graph construction of documents based on layout with prompt learning semantic extraction to automatically identify the layout structure of documents without the need for traditional template constructions. To establish potential relationships between a given key and value, presently described embodiments use different text blocks obtained after OCR as nodes of a knowledge graph and correlates the nodes based on the semantic information and position information from the knowledge graph. When the extraction of the key value structure data is completed, presently described embodiments provide for search capabilities to determine the location of the key value and obtain the potential set of candidate nodes corresponding to the key value based on the constructed knowledge graph. Using prompt technique for key and candidate value discriminations, presently described embodiments provide for a final key value structured output to be obtained. Certain presently described embodiments provide for increased accuracy in zero-sample prediction scenarios that reach up to 85% or higher while only requiring 3-5 samples of fine-tuning to reach more than 95% accuracy.

It may further be appreciated that described embodiments allow users to perform tasks that traditional layout-based approaches are either unable to perform, or only able to perform under complex circumstances that are prone to human error. For example, described embodiments greatly simplify a user's ability to perform multi-hop information extraction by allowing users to input natural language queries that may require combining and transforming semantic and position information derived from multiple nodes within the knowledge graph generated for the target document. Traditional layout-based approaches to information extraction, if capable of performing these tasks, would require highly complicated instructions that are prone to human error and vulnerable to inaccurate queries being input. The flexibility provided by the ability to input natural language phrases as queries is a great benefit to the users of presently described embodiments.

It may be appreciated that FIG. 2 provides only illustrations of an exemplary implementation and does not imply any limitations with regard to how different embodiments may be implemented. Many modifications to the depicted environment may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of extracting information from documents comprising:
receiving a document and performing optical character recognition (OCR) on the received document to obtain OCR text lines and associated bounding boxes;
encoding each of the obtained OCR text lines into semantic vectors and each of the associated bounding boxes into position vectors;
generating a series of fusion vectors by combining the semantic vectors and the position vectors;
building a knowledge graph corresponding to the received document by calculating distances between the generated series of fusion vectors, forming edges where the calculated distances exceed a threshold;
receiving a query including a key value for extracting information from the received document;
in response to receiving the query including the key value, identifying a first node in the knowledge graph corresponding to the OCR text lines including the key value;
identifying a series of candidate nodes comprising a series of most similar nearby nodes positioned near the first node;
generating a prompt template configured to determine closeness of the candidate nodes to the key value and calculate associated confidence levels; and
outputting to a user extracted information associated with the candidate node having a highest calculated confidence level.

2. The computer-based method of claim 1, wherein the semantic vectors are encoded using robustly optimized bidirectional encoder representation from transformers approach (RoBERTa) encoder.

3. The computer-based method of claim 1, wherein the position vectors are generated using a pre-trained neural network-based encoder.

4. The computer-based method of claim 1, wherein the calculated distances between the generated series of fusion vectors are calculated using a k-nearest neighbor algorithm.

5. The computer-based method of claim 1, wherein the first node in the knowledge graph corresponding to the OCR text lines including the key value is identified by employing a series of natural language processing techniques.

6. The computer-based method of claim 1, further comprising:
determining probability values that the candidate nodes include information associated with the key value by converting the calculated associated confidence levels into the probability values using a soft max function.

7. The computer-based method of claim 1, wherein the extracted information associated with the candidate node having the highest calculated confidence level includes one or more of a probability value, the OCR text lines, and position information associated with the OCR text lines.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving a document and performing optical character recognition (OCR) on the received document to obtain OCR text lines and associated bounding boxes;
encoding each of the obtained OCR text lines into semantic vectors and each of the associated bounding boxes into position vectors;
generating a series of fusion vectors by combining the semantic vectors and the position vectors;
building a knowledge graph corresponding to the received document by calculating distances between the generated series of fusion vectors, forming edges where the calculated distances exceed a threshold;
receiving a query including a key value for extracting information from the received document;
in response to receiving the query including the key value, identifying a first node in the knowledge graph corresponding to the OCR text lines including the key value;
identifying a series of candidate nodes comprising a series of most similar nearby nodes positioned near the first node;
generating a prompt template configured to determine closeness of the candidate nodes to the key value and calculate associated confidence levels; and
outputting to a user extracted information associated with the candidate node having a highest calculated confidence level.

9. The computer system of claim 8, wherein the semantic vectors are encoded using robustly optimized bidirectional encoder representation from transformers approach (RoBERTa) encoder.

10. The computer system of claim 8, wherein the position vectors are generated using a pre-trained neural network-based encoder.

11. The computer system of claim 8, wherein the calculated distances between the generated series of fusion vectors are calculated using a k-nearest neighbor algorithm.

12. The computer system of claim 8, wherein the first node in the knowledge graph corresponding to the OCR text lines including the key value is identified by employing a series of natural language processing techniques.

13. The computer system of claim 8, further comprising:
determining probability values that the candidate nodes include information associated with the key value by converting the calculated associated confidence levels into the probability values using a soft max function.

14. The computer system of claim 8, wherein the extracted information associated with the candidate node having the highest calculated confidence level includes one or more of a probability value, the OCR text lines, and position information associated with the OCR text lines.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving a document and performing optical character recognition (OCR) on the received document to obtain OCR text lines and associated bounding boxes;
encoding each of the obtained OCR text lines into semantic vectors and each of the associated bounding boxes into position vectors;
generating a series of fusion vectors by combining the semantic vectors and the position vectors;
building a knowledge graph corresponding to the received document by calculating distances between the generated series of fusion vectors, forming edges where the calculated distances exceed a threshold;
receiving a query including a key value for extracting information from the received document;
in response to receiving the query including the key value, identifying a first node in the knowledge graph corresponding to the OCR text lines including the key value;
identifying a series of candidate nodes comprising a series of most similar nearby nodes positioned near the first node;
generating a prompt template configured to determine closeness of the candidate nodes to the key value and calculate associated confidence levels; and
outputting to a user extracted information associated with the candidate node having a highest calculated confidence level.

16. The computer program product of claim 15, wherein the semantic vectors are encoded using robustly optimized bidirectional encoder representation from transformers approach (RoBERTa) encoder.

17. The computer program product of claim 15, wherein the calculated distances between the generated series of fusion vectors are calculated using a k-nearest neighbor algorithm.

18. The computer program product of claim 15, wherein the first node in the knowledge graph corresponding to the OCR text lines including the key value is identified by employing a series of natural language processing techniques.

19. The computer program product of claim 15, further comprising:
determining probability values that the candidate nodes include information associated with the key value by converting the calculated associated confidence levels into the probability values using a soft max function.

20. The computer program product of claim 15, wherein the extracted information associated with the candidate node having the highest calculated confidence level includes one or more of a probability value, the OCR text lines, and position information associated with the OCR text lines.
